(19) United States
(12) Patent Application Publication
(10) Pub. No.: US 2025/0095656 A1
(43) Pub. Date: Mar. 20, 2025

(54) METHOD AND DEVICE FOR EXECUTING VOICE COMMAND USING PLURALITY OF USER PROFILES OF VEHICLE

(71) Applicants: Hyundai Motor Company, Seoul (KR); Kia Corporation, Seoul (KR)

(72) Inventor: Ran Lee, Seoul (KR)

(21) Appl. No.: 18/635,409

(22) Filed: Apr. 15, 2024

(30) Foreign Application Priority Data
Sep. 20, 2023 (KR) 10-2023-0125801

(51) Int. Cl. G10L 17/22; G01C 21/00; G01C 21/36; G10L 17/02; G10L 17/06

(52) U.S. Cl. CPC G10L 17/22; G01C 21/3608; G01C 21/3682; G01C 21/3811; G01C 21/3856; G10L 17/02; G10L 17/06

(57) ABSTRACT

A method of a vehicle may comprise: based on presence of a first user and a second user in the vehicle, determining that the first user is a driver and the second user is a passenger; applying, based on a first profile of the first user and based on the first user being the driver, profile settings of the first profile to the vehicle; while applying the profile settings of the first profile to the vehicle, detecting a voice command of the second user; and while maintaining at least one profile setting of the profile settings of the first profile to the vehicle: determining, from profile settings of a second profile of the second user and based on the voice command, data for executing the voice command; and executing, based on the data, at least one operation associated with the voice command.

### CROSS REFERENCE TO RELATED APPLICATION

The present application is based on and claims the benefit of priority to Korean Patent Application Number 10-2023-0125801, filed on Sep. 20, 2023 in the Korean Intellectual Property Office, the entire disclosure of which is incorporated herein by reference.

### TECHNICAL FIELD

The present disclosure relates to a method and device for executing a voice command using a plurality of user profiles of a vehicle.

### BACKGROUND

The description in this section merely provides background information related to the present disclosure and does not necessarily constitute the related art.

A vehicle has functions that may store user customized settings for user convenience, such as IMS (Integrated Memory System) and USM (User Setting Menu).

In particular, there is a user profile setting function that improves user convenience by storing the settings of a user in batches and recalling the settings as needed.

Depending on the settings of a user profile, with just one setting, a user may apply, to a vehicle, settings related to vehicle manipulation such as temperature settings, mirror settings, or seat posture stored in the user profile, driving pattern information, recently searched destination information, connection information of a terminal device, and/or vehicle driving information, etc. When a user of a vehicle changes, a new user may apply his/her profile to the vehicle and use settings customized to him or her. As such, a comfortable vehicle operating environment may be provided to a user through user profile settings.

The user profile may also be applied to the voice recognition system of a vehicle. For example, when there is a history of wireless connection between a vehicle and a user terminal, a certificate for wireless connection with the user terminal may be stored in the user profile. If a user utters a voice command to execute an application on the user terminal, the vehicle may be connected to the user terminal using the certificate in the user profile and execute the application on the user terminal. In another example, if a driver utters “let's go home,” the vehicle may set the address that corresponds to a home of a driver profile as the destination.

The application of a pre-stored user profile to a vehicle occurs immediately after starting the vehicle. A driver may select his/her profile among several profiles after starting the vehicle. If the driver does not select a profile for a certain period of time, a recently used profile or a guest profile may be automatically selected. Herein, the guest profile refers to a profile with reduced privileges compared to the registered user profile.

As such, although the profile of a driver is stored in a vehicle, when a different profile is applied (e.g., due to the carelessness of the driver), the driver may feel inconvenience and may need to change the profile applied to the vehicle.

In particular, an issue may occur when a first user and a second user are in a vehicle to which settings according to the profile of the first user are applied, and the second user utters to use information stored in his or her profile. If the vehicle loads the profile of the second user, the first user may not be able to use his or her profile. If the vehicle does not load the profile of the second user, the second user may not be able to use his or her profile.

### SUMMARY

The following summary presents a simplified summary of certain features. The summary is not an extensive overview and is not intended to identify key or critical elements.

According to the present disclosure, a device may use a voice command using a plurality of user profiles of a vehicle. The device comprises a memory configured to store a first user profile for a first user and a second user profile for a second user; and a processor configured to acquire data for executing the voice command of the second user from the second user profile in response to receiving the voice command of the second user in the vehicle to which the first user profile is applied and execute the voice command of the second user based on the data.

A method may use a voice command using a plurality of user profiles of a vehicle. The method comprises receiving a voice command from a second user in a vehicle to which a first user profile for a first user is applied; acquiring data for executing the voice command of the second user from a second user profile for the second user; and executing the voice command of the second user based on the data.

A device of a vehicle may comprise: a memory configured to store a first user profile for a first user of the vehicle and a second user profile for a second user of the vehicle; and a processor configured to: acquire, from the second user profile, data for executing a voice command of the second user in response to receiving the voice command of the second user in the vehicle to which the first user profile is applied; and execute, based on the data, the voice command of the second user.

A method performed by a device of a vehicle may comprise: receiving a voice command from a second user in the vehicle to which a first user profile for a first user is applied; acquiring, from a second user profile for the second user, data for executing the voice command of the second user; and executing, based on the data, the voice command of the second user.

A vehicle may comprise: a memory storing a first user profile for a first user of the vehicle and a second user profile for a second user of the vehicle; and a processor configured to: based on presence of the first user and the second user in the vehicle, determine that the first user is a driver of the vehicle and the second user is a passenger of the vehicle; apply, based on the first user profile and based on the first user being the driver of the vehicle, user profile settings of the first user profile to the vehicle; while applying the user profile settings of the first user profile to the vehicle, detect a voice command of the second user; and while maintaining at least one profile setting of the profile settings of the first user profile to the vehicle: determine, from user profile settings of the second user profile and based on the voice command of the second user, data for executing the voice command of the second user; and execute, based on the data for executing the voice command of the second user, at least one operation associated with the voice command of the second user.

The vehicle may further comprise a wireless transceiver configured to establish, while the user profile settings of the first user profile are applied to the vehicle, a wireless connection with a first user device of the first user. The processor may be configured to execute, while the wireless transceiver maintains the wireless connection with the first user device of the first user, the at least one operation associated with the voice command of the second user.

The vehicle may further comprise a wireless transceiver configured to establish, while the user profile settings of the first user profile are applied to the vehicle, a wireless connection with a first user device of the first user. The processor may be configured to execute, while the wireless transceiver temporarily establishes a wireless connection with a second user device of the second user, the at least one operation associated with the voice command of the second user.

The vehicle may further comprise a camera configured to detect positions of the first user and the second user; and a display configured to display an indication of the at least one operation associated with the voice command of the second user.

These and other features and advantages are described in greater detail below.

### BRIEF DESCRIPTION OF THE DRAWINGS

FIG. 1 is a diagram illustrating a situation in which a user profile applied to a vehicle and a user uttering a voice command do not match.

FIG. 2 is a configuration diagram of a vehicle according to an example of the present disclosure.

FIG. 3 is a diagram illustrating user profiles according to an example of the present disclosure.

FIG. 4 is a flowchart of a voice command execution method according to an example of the present disclosure.

FIG. 5 is a flowchart of device connection according to an example of the present disclosure.

FIG. 6 is a flowchart of navigation control according to an example of the present disclosure.

### DETAILED DESCRIPTION

An object of the present disclosure is to provide a method and device for executing a voice command with reference to a profile of a speaker even though a user profile applied to a vehicle does not match the speaker uttering the voice command.

Embodiment(s) of the present disclosure are described below in detail using various drawings. It should be noted that when reference numerals are assigned to components in each drawing, the same components have the same reference numerals as much as possible, even if they are displayed on different drawings. Furthermore, in the description of the present disclosure, where it has been determined that a specific description of a related known configuration or function may obscure the gist of the disclosure, a detailed description thereof has been omitted.

In describing the components of various features of the present disclosure, symbols such as first, second, i), ii), a), and b) may be used. These symbols are only used to distinguish components from other components. The identity or sequence or order of the components is not limited by the symbols. In the specification, when a part “includes” or is “equipped with” an element, this means that the part may further include other elements, not excluding other elements unless explicitly stated to the contrary. Further, when an element in the written description and claims is described as being “for” performing or carry out a stated function, step, set of instructions, or the like, the element may also be considered as being “configured to” do so.

Each component of a device or method according to the present disclosure may be implemented in hardware or software, or in a combination of hardware and software. In addition, the functions of each component may be implemented in software. A microprocessor or processor may execute functions of the software corresponding to each component.

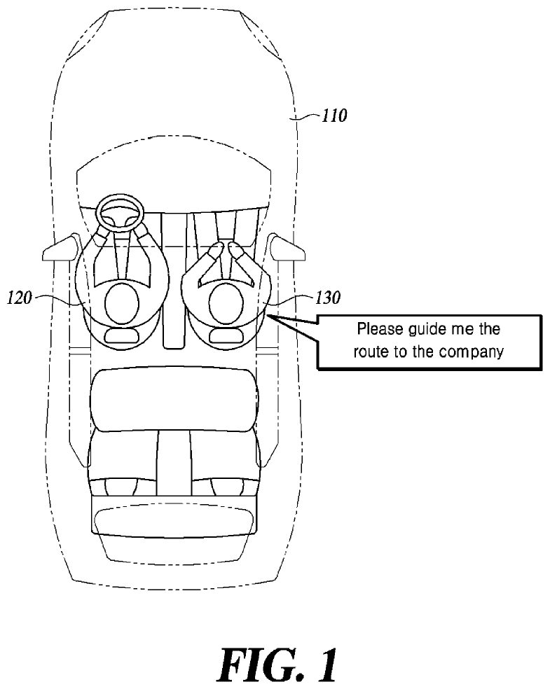

FIG. 1 is a diagram illustrating a situation in which a user profile applied to a vehicle and a user uttering a voice command do not match.

Referring to FIG. 1, a first user 120 and a second user 130 board a vehicle 110. The first user 120 is a driver, and the second user 130 is a fellow passenger.

The vehicle 110 may store user profiles of the first user 120 and the second user 130 in advance. Each user profile may include various settings customized for the respective user. For example, the settings of a profile may include a list of points of interest for a navigation device. The list of the points of interest may include destination names and destination addresses.

After the vehicle 110 is started, the vehicle 110 may output a request to select one user profile among several user profiles. Since the first user 120 is a driver, the profile of the first user 120 may be selected.

Settings according to the profile of the first user 120 are applied to the vehicle 110. As an example, a list of points of interest stored in the profile of the first user 120 may be loaded. In this connection, if the first user 120 utters “Please guide me home,” the vehicle 110 may guide the navigation route to the home address of the first user 120.

However, when the second user 130 utters “Please guide me the route to the company,” the vehicle 110 guides the route to the company address according to the profile of the first user 120, rather than the company address stored in the profile of the second user 130.

As such, when the profile of the first user 120 applied to the vehicle 110 and the second user 130 uttering the voice command do not match, the second user 130 may need to manually change the navigation route, which causes user inconvenience.

However, according to an example of the present disclosure, the vehicle 110 may temporarily use the profile of the second user 130 to execute the voice command of the second user 130. Accordingly, the second user 130 may use the information stored in his or her profile without changing or switching a user profile of the vehicle 110.

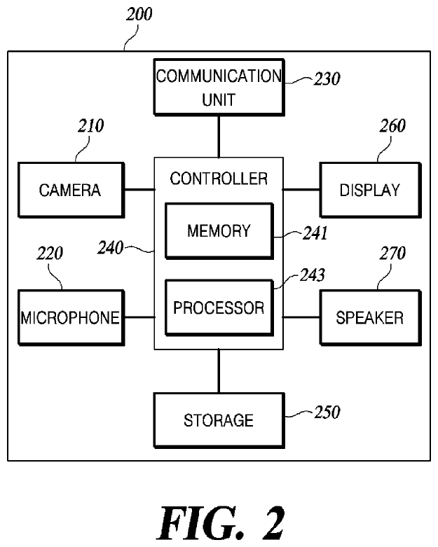

FIG. 2 is a configuration diagram of a vehicle according to an example of the present disclosure.

Referring to FIG. 2, an execution device for executing a voice command according to an example of the present disclosure may be implemented by at least one of a communication unit 230, a controller 240, or a storage 250.

In an example, a vehicle 200 may include a camera 210 that captures a user inside the vehicle, a microphone 220 that receives a voice utterance of a user, the communication device 230 (e.g., a wired and/or wireless communication device, including a wireless modem, a baseband signal processor, a wireless transceiver, a radio frequency transceiver, etc.) that communicates with an external device, the storage 250 that temporarily or non-temporarily stores information necessary for vehicle-related control or provision of services desired by the user, a display 260 that displays a response to the voice utterance of the user, a speaker 270 that outputs sound necessary for the vehicle-related control or provision of services desired by the user, the controller 240 that is electrically connected to components of the vehicle 200 and controls the components, and the storage 250 that store instructions executed by the controller 240.

At least one camera 210 may be mounted at a location capable of capturing a user boarding inside the vehicle 200. The user may refer to a driver and a passenger boarding the vehicle 200.

In another example, the functions of the camera 210 may be performed by a mobile device connected to vehicle 200 and equipped with a separate camera. The connection between the mobile device and the vehicle 200 may be made through wireless communication, such as Bluetooth, or may be made through a wired cable.

The image acquired by the camera 210 may be processed by the controller 240 or an external server that communicates with the communication device 230, depending on the performing entity.

The microphone 220 converts the voice utterance of a user boarding inside the vehicle 200 into an electrical signal.

In another example, the function of microphone 220 may be performed by a mobile device connected to vehicle 200 and equipped with a separate microphone.

The utterance of a user input into the microphone 220 may be processed by the controller 240 or an external server that communicates with the communication device 230, depending on the performing entity.

The communication device 230 is a hardware device implemented with various electronic circuits to transmit and receive a signal through a wireless or wired connection. There is network communication technology within a vehicle, wireless Internet access or short range communication technology with servers and infrastructure outside the vehicle, other vehicles, etc. Herein, the network communication technology within the vehicle includes controller area network (CAN) communication, local interconnect network (LIN) communication, and Flex-Ray communication. Furthermore, the wireless communication technology may include wireless local area network (WLAN), wireless broadband (WiBro), wireless-fidelity (Wi-Fi), world interoperability for microwave access (WiMAX), or the like. Furthermore, the short range communication technology may include Bluetooth, ZigBee, ultra wideband (UWB), radio frequency identification (RFID), infrared data association (IrDA), or the like.

As an example, the communication device 230 may receive data for voice recognition from an external server and may communicate with a device in the vehicle or a terminal device of a user to perform a voice instruction. The communication device 230 may communicate with a mobile device located inside the vehicle 200 to receive information (user video, user utterance, contact information, schedule, etc.) acquired by the mobile device or stored in the mobile device, or may transmit user utterances to an external server and receive information necessary to provide the service desired by the user.

The display 260 may display information indicating a response to a utterance of a user or a status of a vehicle, display information to guide vehicle settings, display a navigation screen, display multimedia content, or display information related to driving.

As an example, the display 260 may include an Audio Video Navigation (AVN) display.

If a touch sensor such as a touch film, a touch sheet, or a touch pad is provided on the display 260, the display 260 may operate as a touch screen, and may be implemented in a form in which an input device and an output device are integrated.

The display 260 may include at least one of a liquid crystal display (LCD), a thin film transistor liquid crystal display (TFT LCD), an organic light emitting diode display (OLED display), a flexible display, a field emission display (FED), or a 3D display.

The speaker 270 may output a sound necessary for vehicle-related control or for providing a service desired by a user.

The storage 250 may store data necessary for the controller 240 to operate, at least one instruction, or a voice recognition-related algorithm.

The storage 10 may include at least one type of storage medium of a memory such as a flash memory type, a hard disk type, a micro type, and a card type (for example, an Secure Digital (SD) card or an eXtream Digital (XD) card), and a memory such as a RAM (Random Access Memory), an SRAM (Static RAM), a ROM (Read-Only Memory), a PROM (Programmable ROM), an EEPROM (Electrically Erasable PROM), a Magnetic Memory (MRAM), a magnetic disk, and an optical disk type.

The storage 250 may be implemented as a single device with a memory 241.

The controller 114 may be electrically coupled to the camera 210, the microphone 220, the communication device 230, the storage 250, the display 260, or the speaker 270, may control each component, and may include an electrical circuit that executes software commands, performing various data processing and calculations described below.

To this end, the controller 240 may include the memory 241 and a processor 243. The memory 241 may include at least one instruction, and the processor 243 may control components of the vehicle 200 by executing at least one instruction.

The processor 243 may execute a voice recognition module for converting a voice of a user into text, a natural language understanding module for understanding the domain and intent of the text, and a result processing module that generates a response to the voice of the user or a control command of the vehicle 200 based on the domain and intent.

The processor 243 may execute a voice command of a user using a plurality of user profiles. In an example, the memory 241 stores the plurality of user profiles. The processor 243 recognizes a voice of the user input through the microphone 220, performs user authentication based on the voice of the user, and executes the voice command of the user using information stored in the authenticated user's profile.

In the process of recognizing a voice of a user, the processor 243 may classify the domain of a voice command of the user. Herein, the domain includes user device control, navigation control, driving control, media playback control, or air conditioning device control. The user device control may be related to phone connection, music playback, and information search through a device of the user connected to the vehicle 200.

If a voice command of a user is related to user device control, the processor 243 establishes a wireless connection with a user device using a device authentication certificate in the profile applied to a vehicle and transmits a control command according to the voice command of the user to the user device. Thereafter, the user device may perform functions according to the control command in conjunction with the processor 243. For example, the user device may play music according to control commands.

The authentication certificate represents password information used to connect between the communication device 230 and the user device, and may be stored in the user profile.

If a voice command of a user is related to navigation control, the processor 243 identifies the destination according to the voice command based on a list of points of interest in the user profile applied to a vehicle. The processor 243 may provide a route to the identified destination.

Furthermore, the processor 243 may perform user authentication by comparing the voice data of a user with previously collected reference voice data.

The user authentication may be performed using a server. The processor 243 transmits the voice data of a user to the server, and the server authenticates the user based on the voice data of the user. The server may authenticate a user by comparing the previously stored voice data of the user with the voice data received from the vehicle 200. The server transmits a user authentication result to the vehicle 200.

As such, the processor 243 may directly process a user image captured by the camera 210 or a utterance of a user input into the microphone 220, or transmit the same to an external server through the communication unit 230.

Although the user profile applied to a vehicle and a voice command of a user input through the microphone do not match, the processor 243 may execute the voice command with reference to the profile of the user uttering the voice command. Accordingly, the processor 243 may provide a service according to the voice command without changing a user profile or making an utterance by the user of the user profile applied to a vehicle.

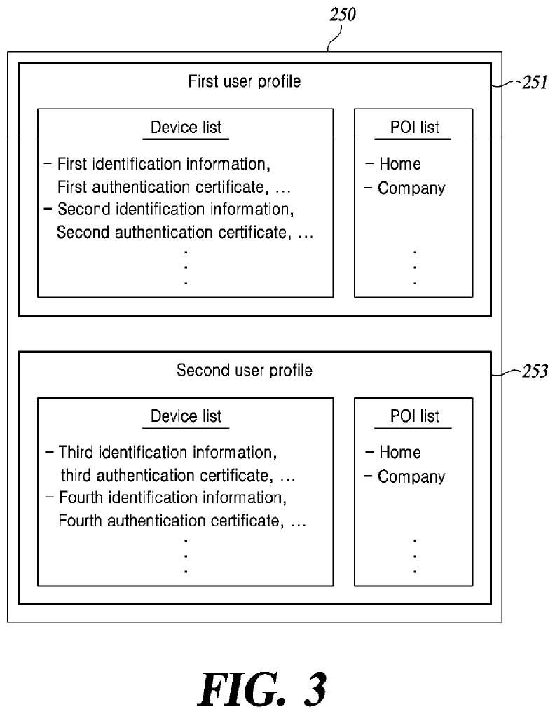

FIG. 3 is a diagram illustrating user profiles according to an example of the present disclosure.

Referring to FIG. 3, the storage 250 of a vehicle may store a plurality of user profiles 251 and 253. A first user profile 251 is a profile related to an account of the first user, and a second user profile 253 is a profile related to an account of the second user.

The first user profile 251 and the second user profile 253 each include various settings. In FIG. 3, each example user profile includes a list of devices and list of points of interest. Each user profile may include other types of user information, such as one or more lists of media content (e.g., favorite music lists), one or more lists of radio channels, a phone contact list, an email contact list, subscription information and profile information for streaming services, driver seat settings, passenger seat settings, etc. For example, each user may have different preferences for seat adjustments for the driver seat and one or more passenger seats.

The device list relates to user devices connected to a vehicle while the user profile is applied to the vehicle. The device list may include identification information and authentication certificate of the user device.

As an example, the first user profile 251 may include first identification information of a first user device of the first user, and a first authentication certificate used to connect with the first user device. The first user profile 251 may include second identification information of a second user device of the first user, and a second authentication certificate used to connect with the second user device.

If the first user profile 251 is applied to a vehicle, an execution device for executing a voice command may be in communication connection with the devices of the first user using the device list of the first user profile 251. The execution device may search for devices matching the identification information in the first user profile 251 among devices existing in the vehicle and complete connection with the scanned device using an authentication certificate. In this connection, a connection attempt is made according to the priority of devices in the device list, and a connection may be made without the consent of the first user.

The list of points of interest includes names and addresses of points of interest (PoI) for each user. As an example, the list of points of interest may include the home address and company address of a user.

If the first user profile 251 is applied to a vehicle and guidance on a route to home is requested, the execution device sets the home address in the first user profile 251 as the destination and provides the route to the destination.

In addition, settings stored in each user profile may include biometric information such as fingerprints and blood type, personal information such as name and age, seat position, drive mode, sound settings, navigation search options, mirror posture, and steering wheel location, or parameters of an air conditioning device. Additionally, for user authentication, each user profile may include reference feature vectors for a voice of a user.

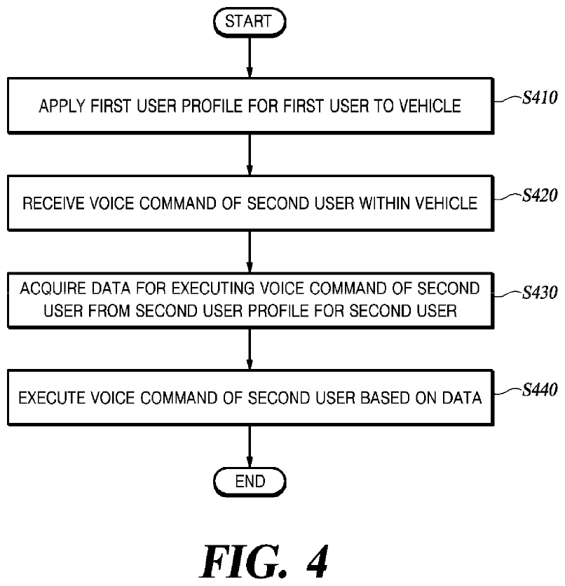

FIG. 4 is a flowchart of a voice command execution method according to an example of the present disclosure.

Referring to FIG. 4, an execution device for executing a voice command applies the first user profile for the first user to a vehicle (S410).

In an example, the first user and the second user may board a vehicle, and the second user may carry a second user device. The execution device may store a first user profile for the first user and a second user profile for the second user.

The execution device may request users in a vehicle to select a user profile and apply the first user profile selected by the first user to the vehicle. Alternatively, when a user profile is not selected for a predetermined period of time, the execution device may apply a high priority user profile or a recently applied user profile to the vehicle. Accordingly, the execution device may apply the first user profile to the vehicle. In another example, a camera of the vehicle may detect a user seating on the driver seat and select the user profile of the user seating on the driver seat.

The vehicle is controlled according to settings such as seat position, drive mode, or sound settings in the first user profile. The vehicle may establish a wireless connection with a mobile device of the first user, for example, after selecting the first user profile for application to the vehicle.

Thereafter, the execution device receives a voice command of the second user within a vehicle (S420). In an example, the voice command may be received while the vehicle has established the wireless connection with the mobile device of the first user after applying the first user profile to the vehicle and determining the first user as the driver of the vehicle.

The execution device acquires data for executing the voice command of the second user from the second user profile for the second user (S430). In an example, without switching the established wireless connection and without changing the applied first user profile, the second user profile may be retrieved for executing the voice command of the second user.

Even when the first user profile is applied to the vehicle, the execution device may retrieve data from the second user profile to execute the voice command of the second user. In this connection, if the voice command of the second user is a command related to a safety function, the execution device may ignore the voice command of the second user. For example, the safety function may include one or more functions associated with the current driver of the vehicle (e.g., controlling the movement of the vehicle, controlling the speed of the vehicle, changing the lane, opening the door of the driver seat, adjusting side mirrors, rearview mirror, etc.)

If the voice command of the second user is related to user device control, the execution device may acquire an authentication certificate for wireless connection with the second user device from the second user profile.

When the voice command of the second user is related to navigation control, the execution device may acquire a list of points of interest in the second user profile.

The execution device executes the voice command of the second user based on the data (S440).

If the voice command of the second user is related to user device control, the execution device may establish a connection with the second user device based on an authentication certificate for the second user device. In this connection, the execution device may preferentially attempt a connection to the second user device among the first user device registered in the first user profile and the second user device. If the execution device is connected to the first user device in a vehicle according to the application of the first user profile, the execution device may disconnect from the first user device in order to (e.g., temporarily) connect to the second user device. After completing the execution of the voice command and a timer expires, the execution device may reconnect to the first user device.

After the connection to the second user device, the execution device controls the second user device according to the voice command of the second user. As an example, when the voice command of the second user is to play music, the execution device may transmit a control command to the second user device to cause the second user device to play music.

If the voice command of the second user is related to navigation control, the execution device identifies the destination according to the voice command of the second user from the list of points of interest in the second user profile and provides a route to the destination. When the second user utters “Please drop me off at my office,” the execution device provides a route to the company address included in the list of points of interest of the second user profile, rather than to the company address included in the list of points of interest of the first user profile.

As such, the execution device may use the second user profile to execute the voice command of the second user even when the first user profile is applied to the vehicle.

In another example, the execution device may change the user profile applied to the vehicle. In other words, the execution device may apply the second user profile to the vehicle instead of the first user profile.

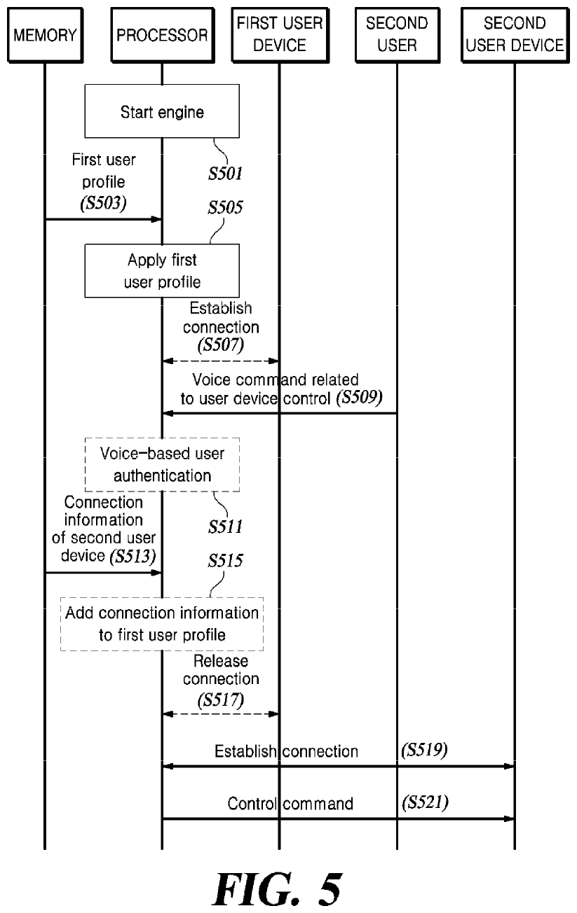

FIG. 5 is a flowchart of device connection according to an example of the present disclosure.

Referring to FIG. 5, a flow in which the processor of a vehicle connects to and controls a second user device using a plurality of user profiles is illustrated.

It is assumed that the first user device, the second user, and the second user device exist within a vehicle. The first user may board the vehicle. Additionally, a first user profile for the first user and a second user profile for the second user are stored in the memory of the vehicle and/or a server connected via a wireless connection. Each user profile may include a list of the devices of a user. The first user profile may include an authentication certificate for the first user device, and the second user profile may include an authentication certificate for the second user device.

In step S501, the processor starts a vehicle.

In step S503, the processor retrieves the first user profile stored in memory.

In an example, the processor may request users in the vehicle to select a user profile through the display. Among the first user profile and the second user profile stored in the memory, the first user profile may be selected according to the input of a user, and the processor loads the first user profile. Otherwise, if there is no user input for a predetermined period of time and the most recently applied profile is the first user profile, the processor may automatically load the first user profile.

In step S505, the processor applies the first user profile to the vehicle.

The vehicle is controlled according to the settings in the first user profile. For example, the seats of the vehicle may be adjusted according to the seat position in the first user profile, and the vehicle may be switched to a drive mode according to the first user profile.

In step S507, the processor may establish a connection with the first user device.

In particular, the processor may attempt connect according to priority within the device list of the first user profile.

If there is a connection history with the first user device, the first user profile may include identification information and an authentication certificate of the first user device. The processor may be connected to the first user device based on an authentication certificate of the first user device in the first user profile. As an example, the processor may be connected to the first user device via a wireless connection (e.g., Bluetooth). However, step S507 may be omitted. For example, the first user device may not exist in a vehicle.

Thereafter, a vehicle may travel with the first user profile being applied.

In step S509, the second user utters a voice command related to user device control.

The processor may classify the domain of the voice command as user device control using the voice recognition of the second user. For example, the second user may utter “Call a friend.”

In step S511, the processor may perform user authentication based on a voice of the second user.

As an example, the processor determines whether the second user is a user registered in the second user profile based on a comparison between sound features extracted from the voice command of the second user and reference sound features registered by the second user. To this end, the reference sound features of the second user may be stored in advance.

As another example, the processor may transmit a voice command of the second user to the server and receive a user authentication result processed by the server. The server may determine whether the second user is a legitimate user based on a comparison between sound features extracted from the voice command of the second user and reference sound features registered by the second user.

Thus, the processor may recognize that the person who uttered the voice command is the second user of the second user profile.

If the second user is not authenticated, the processor may ignore the voice command of the second user or proceed with user authentication again. In at least some implementations, step S511 may be omitted.

In step S513, if the second user is authenticated, the processor receives connection information of the second user device from the second user profile in the memory in order to execute the device control-related voice command of the second user.

The connection information of the second user device includes identification information and an authentication certificate of the second user device. The authentication certificate is for wireless connection with the second user device.

In step S515, the processor may add connection information of the second user device to the first user profile.

This is because in step S519, the processor attempts to connect devices in the order of devices registered in the first user profile. However, step S515 may be omitted in at least some implementations.

In step S517, if the processor is connected to the first user device, the processor may release the connection with the first user device.

In this connection, the processor may partially disconnect the connection with the first user device. In the case of a Bluetooth connection, the processor may release the connection on a per-Bluetooth profile basis. In detail, the processor may release one of the Hands Free Profile (HFP) or the Advanced Audio Distribution Profile (A2DP) required for execution of a voice command in connection with the first user device.

In at least some implementations, step S517 may be omitted along with step S507.

In step S519, the processor may establish a connection with the second user device based on an authentication certificate of the second user device acquired from the second user profile.

If the second user device is registered in the device list of the first user profile, the processor sequentially attempts connection to devices in the device list of the first user profile.

In particular, the processor may preferentially attempt connection to the second user device among the first user device stored in the first user profile and the second user device.

In stage S521, the processor controls the second user device by transmitting a control command according to a voice command of the second user to the connected second user device.

Accordingly, the processor may make a call to a friend of the second user using the second user device.

Thereafter, if the engine of a vehicle is turned off or the vehicle enters sleep mode, data added to the first user profile may be deleted.

According to the aforementioned steps, the processor may execute a voice command of the second user with reference to the second user profile even though the first user profile is applied to a vehicle.

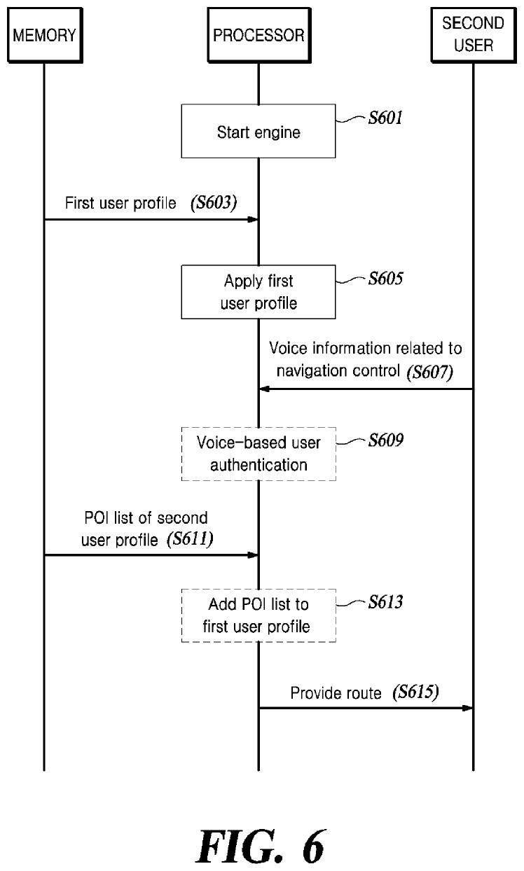

FIG. 6 is a flowchart of navigation control according to an example of the present disclosure.

Referring to FIG. 6, a flow in which the processor of a vehicle performs a navigation control-related voice command of the second user using a plurality of user profiles is illustrated.

The first user profile and the second user profile are stored in the memory. Each user profile includes a list of points of interest of a user. The first user profile includes a list of points of interest for the first user, and the second user profile includes a list of points of interest for the second user. Each list of points of interest is stored by matching the destination name and destination address.

Steps S601 to S605 may be the same as steps S501 to S505, and step S609 may be the same as step S511, so repetitive descriptions are omitted.

In step S607, the second user utters a voice command related to navigation control.

The processor may classify the domain of the voice command of the second user as navigation control using the voice recognition of the second user. For example, the second user may utter “Please drop me off at my office.”

In step S611, a list of points of interest is received from the second user profile in the memory in order to execute the device control-related voice command of the second user.

The list of points of interest of the second user profile may include a home address, company address, etc. registered by the second user.

In stage S613, the processor may add the list of points of interest of the second user profile to the first user profile.

In this connection, if there are overlapping points of interest among the list of points of interest of the first user profile and the list of points of interest of the second user profile, the list of points of interest of the second user profile may take priority.

In at least some implementations, step S613 may be omitted.

In step S615, the processor identifies the destination according to the voice command of the second user from the list of points of interest in the profile of the second user and provides a route to the destination.

As an example, the processor may provide a route to the company of the second user.

According to the aforementioned steps, the processor may execute the voice command of the second user with reference to the second user profile even though the first user profile is applied to a vehicle.

According to an example of the present disclosure, even though the user profile applied to the vehicle does not match the speaker uttering the voice command, the voice command can be executed with reference to the profile of the speaker.

Various techniques described herein may be implemented in digital electronic circuitry, or in computer hardware, firmware, software, or combinations thereof. Implementations may be in the form of a computer program tangibly embodied in a computer program product, such as, an information carrier, e.g., a machine-readable storage device (computer-readable medium) or a propagated signal, for processing by, or controlling, the operation of, a data processing device, e.g., a programmable processor, a computer, or a number of computers. A computer program, such as the above-mentioned computer program(s), may be written in any form of programming language, including compiled or interpreted languages and may be deployed in any form, including as a stand-alone program or as a module, component, subroutine, or other unit suitable for use in a computing environment. The computer program may be deployed to run on a single computer or multiple computers at one site or distributed across multiple sites and interconnected by a communications network.

In addition, components of the present disclosure may use an integrated circuit structure such as a memory, a processor, a logic circuit, a look-up table, and the like. These integrated circuit structures execute each of the functions described herein through the control of one or more microprocessors or other control devices. In addition, components of the present disclosure may be specifically implemented by a program or a portion of a code that includes one or more executable instructions for performing a specific logical function and is executed by one or more microprocessors or other control devices. In addition, components of the present disclosure may include or be implemented as a Central Processing Unit (CPU), a microprocessor, etc. that perform respective functions. In addition, components of the present disclosure may store instructions executed by one or more processors in one or more memories.

Processors suitable for processing computer programs include, by way of example, both general purpose and special purpose microprocessors, as well as one or more processors of any kind of digital computer. Generally, a processor will receive instructions and data from a read-only memory or a random access memory or both. The essential elements of a computer may include at least one processor that executes instructions and one or more memory devices that store instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include, by way of example, semiconductor memory devices, e.g., Magnetic Media such as hard disks, floppy disks, and magnetic tapes, Optical Media such as Compact Disk Read Only Memories (CD-ROMs) and Digital Video Disks (DVDs), Magneto-Optical Medial such as Floptical Disks, Rea Only Memories (ROMs), Random Access Memories (RAMs), flash memories, Erasable Programmable ROMs (EPROMs), Electrically Erasable Programmable ROMs (EEPROM), etc. The processor and the memory may be supplemented by, or incorporated in, special purpose logic circuitry.

The processor may execute an Operating System and software applications executed on the Operating System. Moreover, a processor device may access, store, manipulate, process, and generate data in response to software execution. For the sake of convenience, there is a case where a single processor device is used, but those skilled in the art will understand that the processor device can include multiple processing elements and/or multiple types of processing elements. For example, the processor device may include a plurality of processors or a single processor and a single controller. Other processing configurations, such as such as parallel processors, are also possible.

In addition, non-transitory computer-readable media may be any available media that can be accessed by a computer, and may include both computer storage media and transmission media.

This specification includes details of various specific implementations, but they should not be understood as limiting the scope of any invention or what is claimed, and should be understood as descriptions of features that may be unique to particular examples of a particular invention. In the context of individual examples, specific features described herein may also be implemented in combination with a single embodiment. On the contrary, various features described in the context of a single embodiment can also be implemented in multiple embodiments independently or in any appropriate sub-combination. Further, although the features may operate in a particular combination and may be initially described as so claimed, one or more features from the claimed combination may be in some cases excluded from the combination, and the claimed combination may be modified into a sub-combination or a variation of the sub-combination.

Likewise, although the operations are depicted in the drawings in a particular order, it should not be understood that such operations must be performed in that particular order or sequential order shown to achieve the desirable result or that all the depicted operations should be performed. In certain cases, multitasking and parallel processing may be advantageous. Moreover, the separation of various device components of the above-described examples should not be understood as requiring such separation in all examples, and it should be understood that the described program components and devices can generally be integrated together in a single software product or packaged into multiple software products.

The foregoing description is merely illustrative of the technical concept of the present disclosure. Various modifications and changes may be made by those of ordinary skill in the art without departing from the essential characteristics of each embodiment. Therefore, examples of the present disclosure are not intended to limit but to describe the technical idea of the present disclosure. The scope of the technical concept described herein is not limited by these examples. The scope of protection of the various features of the present disclosure should be construed by the following claims. All technical ideas that fall within the scope of equivalents thereof should be interpreted as being included in the scope of the present disclosure.

What is claimed is:

1. A device of a vehicle, the device comprising:
a memory configured to store a first user profile for a first user of the vehicle and a second user profile for a second user of the vehicle; and
a processor configured to:
acquire, from the second user profile, data for executing a voice command of the second user in response to receiving the voice command of the second user in the vehicle to which the first user profile is applied; and
execute, based on the data, the voice command of the second user.

2. The device of claim 1, wherein the voice command of the second user relates to user device control, and the data includes an authentication certificate for wireless connection with a second user device of the second user.

3. The device of claim 2, wherein the processor is configured to establish a connection with the second user device based on the authentication certificate and control the second user device according to the voice command of the second user.

4. The device of claim 3, wherein the processor is configured to attempt, based on the voice command of the second user, a connection to the second user device among at least one first user device associated with the first user profile and the second user device.

5. The device of claim 3, wherein, when connected to a first user device of the first user in the vehicle, the processor releases a connection with the first user device in order to be connected with the second user device.

6. The device of claim 1, wherein the voice command of the second user relates to navigation control and the data includes a list of points of interest in the second user profile.

7. The device of claim 6, wherein the processor is configured to identify a destination according to the voice command of the second user from the list of points of interest and provide a route to the destination.

8. The device of claim 1, wherein the processor is configured to determine whether the second user is a user registered in the second user profile based on a comparison of sound features extracted from the voice command of the second user and reference sound features registered by the second user.

9. A method performed by a device of a vehicle, the method comprising:
receiving a voice command from a second user in the vehicle to which a first user profile for a first user is applied;
acquiring, from a second user profile for the second user, data for executing the voice command of the second user; and
executing, based on the data, the voice command of the second user.

10. The method of claim 9, wherein the voice command of the second user relates to user device control, and the data includes an authentication certificate for wireless connection with a second user device of the second user.

11. The method of claim 10, wherein the execution of the voice command comprises:
establishing a connection with the second user device based on the authentication certificate; and
controlling the second user device according to the voice command of the second user.

12. The method of claim 11, wherein the establishing the connection with the second user device comprising:
attempting, based on the voice command of the second user, a connection to the second user device among at least one first user device associated with the first user profile and the second user device.

13. The method of claim 11, further comprising:
when connected to a first user device of the first user in the vehicle, releasing a connection with the first user device in order to be connected with the second user device.

14. The method of claim 9, wherein the voice command of the second user relates to navigation control and the data includes a list of points of interest in the second user profile.

15. The method of claim 14, wherein the execution of the voice command comprises:
identifying a destination according to the voice command of the second user from the list of points of interest; and
providing a route to the destination.

16. The method of claim 9, further comprising:
determining whether the second user is a user registered in the second user profile based on a comparison of sound features extracted from the voice command of the second user and reference sound features registered by the second user.

17. A vehicle comprising:
a memory storing a first user profile for a first user of the vehicle and a second user profile for a second user of the vehicle; and
a processor configured to:
based on presence of the first user and the second user in the vehicle, determine that the first user is a driver of the vehicle and the second user is a passenger of the vehicle;
apply, based on the first user profile and based on the first user being the driver of the vehicle, user profile settings of the first user profile to the vehicle;
while applying the user profile settings of the first user profile to the vehicle, detect a voice command of the second user; and
while maintaining at least one profile setting of the profile settings of the first user profile to the vehicle:
determine, from user profile settings of the second user profile and based on the voice command of the second user, data for executing the voice command of the second user; and
execute, based on the data for executing the voice command of the second user, at least one operation associated with the voice command of the second user.

18. The vehicle of claim 17, further comprising:
a wireless transceiver configured to establish, while the user profile settings of the first user profile are applied to the vehicle, a wireless connection with a first user device of the first user,
wherein the processor is configured to execute, while the wireless transceiver maintains the wireless connection with the first user device of the first user, the at least one operation associated with the voice command of the second user.

19. The vehicle of claim 17, further comprising:
a wireless transceiver configured to establish, while the user profile settings of the first user profile are applied to the vehicle, a wireless connection with a first user device of the first user,
wherein the processor is configured to execute, while the wireless transceiver temporarily establishes a wireless connection with a second user device of the second user, the at least one operation associated with the voice command of the second user.

20. The vehicle of claim 17, further comprising:
a camera configured to detect positions of the first user and the second user; and
a display configured to display an indication of the at least one operation associated with the voice command of the second user.
